(19) United States
(12) Patent Application Publication
(10) Pub. No.: US 2008/0148974 A1
(43) Pub. Date: Jun. 26, 2008

(54) Printing Press with Printing Plate Manipulation Device

(75) Inventors: Karlheinz Hugel, Heidelberg (DE); Rudi Stellberger, Kronau (DE); Kai Albrecht, Heidelberg (DE); Peter Heiler, Forst (DE); Klaus-Dieter Kleibaumhuter, Bad Schonborn (DE); Manuela Krasniqi, Hockenheim (DE); Michael Kruger, Edingen-Neckarhausen (DE); Jurgen Kunz, Leimen (DE); Burkhard Maass, Heidelberg (DE); Jurgen Maass, Wiesloch (DE); Gerd Merkel, Dielheim (DE); Helmut Meyer, Wiesloch (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/963,954

(22) Filed: Dec. 24, 2007

(30) Foreign Application Priority Data
Dec. 22, 2006 (DE) 102006062160.3

(51) Int. Cl. B41F 13/24

(52) U.S. Cl. 101/248

(57) ABSTRACT

A printing press includes at least one printing unit having a cylinder and a cover covering the cylinder. Actuators are associated with the cylinder for changing a geometry of the cover in axial and/or circumferential direction of the cylinder. Positioning electronics are connected to the actuators and a printing press machine control system is connected to the positioning electronics. An image inspection device is connected to the printing press machine control system at least for geometric measurement of printed printing materials. A printing press computer processes measured results from the image inspection device for carrying out a desired/actual value comparison and for driving the actuators to minimize determined deviations, in the event that deviations are determined.

### CROSS-REFERENCE TO RELATED APPLICATION

This application claims the priority, under 35 U.S.C. § 119, of German patent Application DE 10 2006 062 160.3, filed Dec. 22, 2006; the prior application is herewith incorporated by reference in its entirety.

### BACKGROUND OF THE INVENTION

### Field of the Invention

The present invention relates to a printing press including at least one printing unit having a cylinder covered with a cover.

In sheet-fed rotary printing presses, the plate cylinders and blanket cylinders in individual printing units of the printing press are provided with clamping and tensioning devices which permit the rubber blankets and the printing plates to be changed. It is thus possible for new printing plates to be clamped onto the associated cylinders in the respective printing units for each new print job. According to the prior art, the printing plates are fixed to the plate cylinder through the use of a hydraulic or pneumatic tensioning and clamping device. Such a clamping device for fixing printing plates on a cylinder in the printing unit of a printing press is disclosed by German Patent DE 41 29 831 C3, corresponding to U.S. Pat. No. 5,184,554. In that case, the printing plate is fixed on the printing cylinder through the use of a stationary upper clamping bar and a lower clamping bar that can be displaced radially with respect thereto. The actuating elements of the lower clamping bar can operate pneumatically or hydraulically in that case.

In addition, European Patent EP 0 530 612 B1 discloses electric activation of tensioning rails on the plate cylinder. In that case, at least one tensioning rail has an electric motor with a position feedback device for register corrections, in which the electric motor is remotely adjustable. In addition, the electric drives on the plate cylinder are supplied with electrical energy and actuating commands from outside the plate cylinder through a contact-free transmitter. At the same time, data from the position transducer is transmitted from the cylinder to the control unit, located outside the cylinder, by the electric transmitter. The transmitter includes a two-part transformer, with both electrical energy and data being transmitted through the use of the element implemented as an inductive transmitter. In addition, there are power electronics on the plate cylinder for driving selected actuating motors of the tensioning rail. The intention is thus for register corrections in the printed image to be carried out by adjusting the tensioning rail with the electric motors.

However, during the printing process there is often the problem that the geometries of the printed image become distorted slightly due to moisture and the nature of the paper. Those geometric changes cannot be overcome with actuating devices on the tensioning rail of a plate cylinder because of their partly non-uniform local dependence over the entire printed image.

### SUMMARY OF THE INVENTION

It is accordingly an object of the invention to provide a printing press with a printing plate manipulation device, which overcomes the hereinafore-mentioned disadvantages of the heretofore-known devices of this general type and which permits automatic correction of geometric deviations in a printed image.

With the foregoing and other objects in view there is provided, in accordance with the invention, a printing press, comprising at least one printing unit having a cylinder and a cover covering the cylinder. Actuators are associated with the cylinder for changing a geometry of the cover in an axial and/or circumferential direction of the cylinder. Positioning electronics are connected to the actuators and a printing press machine control system is connected to the positioning electronics. An image inspection device is connected to the printing press machine control system at least for geometric measurement of printed printing materials. A printing press computer processes measured results from the image inspection device for carrying out a desired/actual value comparison and for driving the actuators to minimize determined deviations, in the event that deviations are determined.

The present invention can be applied in the printing unit of offset printing presses, both on the plate cylinder and on the blanket cylinder. It is also possible, in a single printing unit, for both the plate cylinder and the blanket cylinder to be equipped with the actuators according to the invention. The actuators on the cylinder are actuating devices with which the geometry of the respective cover or dressing on the cylinder can be changed in the axial and/or circumferential direction of the cylinder. The cover can be elongated, stretched or otherwise deformed. On the plate cylinder, the cover is the printing plate while, in the case of the blanket cylinder, the rubber blanket represents the cover or dressing. Through the use of the actuators on the respective cylinder, it is now possible for the cover to be deformed in such a way that any geometric deviations determined in the printed image can be corrected by the deformation, so that geometric deviations can be counteracted. For this purpose, there is expediently a plurality of actuators on the cylinder, so that the cover can be deformed specifically over the entire printed image. Such a deformation of the cover is also designated as a manipulation of the printing plate or of the rubber blanket.

In accordance with another feature of the invention, the actuators are at least partly electrically driven. Electrically driven actuators have the advantage that the energy supply to a rotating component such as the plate cylinder or blanket cylinder can be provided relatively unproblematically through the use of a rotary electric transmitter. In particular, through the use of electrically driven actuators, it is also possible to deform the cover while cylinders are rotating. In addition, electric actuators can be driven precisely and can be incorporated easily in the machine control system. In this case, the actuators are implemented as rotationally operating electric motors, such as appear as servo drives in actuating motors, for example. Alternatively, it is also possible to use piezoelectric drives for the actuators. The piezoelectric drives have the advantage that they exhibit barely any wear phenomena and, in addition, permit highly accurate actuating operations, as long as the actuating travel is relatively small. However, the intended deformations of the plate cylinder involve relatively short travels, so that in this case piezoelectric drives can be used. If a greater adjustment travel is required, electromagnetic reciprocating drives can also be used. Furthermore, thought is also given to the use of electric linear motors if relatively large adjustment travels are necessary. In particular, when rotating electric motors are used, the torque can be increased through a gear mechanism, which may be necessary because of the high forces in elongating a printing plate.

In accordance with a further feature of the invention, a registering device for feeding back the position of the actuators is provided. Such a registering device for feeding back the position of the actuators makes it possible for the operating personnel to check the set deformation. The position of the actuators that is reached can be displayed on a monitor of the printing press for this purpose, so that the operating personnel, if appropriate, can correct the indicated position once more before printing. In this case, the registering device being used can be a rotary encoder, which is able to feed back a relative position of the actuator. However, the use of absolute rotary encoders is also possible, so that even after a power failure or a failure of the transmission system, the absolute position of the actuators can always be fed back. Furthermore, the use of a reference switch as a registering device is possible. In the case of this reference switch, the actuators will fall onto a mechanical stop before the actuating operation, in order to define the zero point in this way. In the case of this mechanical stop, there need be no electronics in order to register the position of the actuator. However, this method is not as accurate since, in the event of a plurality of revolutions of a motor away from stop, the position becomes less accurate as a result of tolerances.

In accordance with an added feature of the invention, provision is made for there to be positioning electronics for driving the actuators, which are located on or in the cylinder of the printing press. These positioning electronics have appropriate interfaces for the connection of the actuators. Advantageously, in this case, the feedback signals from the actuators do not need to be led out of the cylinder first but can be evaluated directly on the cylinder by the positioning electronics. In this case, a closed control loop can be implemented within the cylinder, since the positioning electronics can compare the control commands sent by the printing press control system with the fed-back actual positions of the actuators directly on site and, if appropriate, can control out deviations that are determined. Thus, the proportion of signals which have to be transmitted between the cylinder and the printing press control system becomes smaller.

In accordance with an additional feature of the invention, the electrical energy for driving the actuators on the cylinder can be transmitted to the same through a rotary electric transmitter. Such a rotary transmitter can operate on the induction principle, as a result of which, in particular, higher current intensities for the supply of the actuators are possible. However, control signals which are modulated on and which contain control commands for the actuators can additionally also be transmitted through such an inductive transmitter. Moreover, it is possible for the rotary transmitter for transmitting the electrical signals to operate with radio transmission or a capacitive coupling. In this case, even higher frequency control signals can be transmitted reliably. Furthermore, the use of optical transmitters is envisaged. In particular, for the transmission of energy, use can also be made of a slip-ring transmitter, which is disposed rotationally symmetrically with respect to the cylinder axis. It is additionally possible to split the rotary transmitter into two parts, one part, at one end of the cylinder having the actuators, transmitting electrical data to the cylinder, while the other part of the rotary transmitter, at the other end of the cylinder, transmitting electrical energy to the cylinder. Of course, the transmission of the electrical energy and in particular of the electrical data can be implemented bidirectionally, so that electrical data as well as electrical energy can also flow back from the cylinder into the control system of the printing press. The positions of the actuators can be fed back to the printing press control system and, if appropriate, displayed to the operating personnel through the use of this type of data transmission.

In accordance with yet another feature of the invention, provision is made for the actuators to operate at least partly pneumatically. In particular, when the cover on the cylinder is to be deformed when at a standstill, recourse can also be had to the use of pneumatic actuators. It is additionally possible to modify the pneumatic actuators used nowadays for clamping the cover on the cylinder and to use them for the deformation of the cover as well. Furthermore, there can be both electric and pneumatic actuators on the cylinder. Therefore, any pneumatic actuators which are also responsible for clamping the plate on the cylinder can be supplemented by electric actuators, which permit flexible elongation of the cover over the entire printed image. It is also possible for combined actuators on the cylinder which have both electric and pneumatic functions to be used. These combined actuators have both a pneumatic and an electric drive. In particular, in this case too, the pneumatic drive can be used to assist the electric drives when at a standstill. Greater forces can also be transmitted with the same overall size by using the pneumatic actuators. For example, it is also conceivable for the pneumatic part of the actuators to perform the greater adjustment travel during elongation, while the fine adjustment with a small movement travel is carried out by the electric part. In order to supply the pneumatic actuators on the cylinder, the mounting of the cylinder can be provided with a leadthrough, which permits the pneumatic compressed air supply to the cylinder. Such a leadthrough is preferably operated only when the cylinder is at a standstill, since in the case of a rotating cylinder, sealing with respect to pressure loss is very difficult, although possible. For this reason, the adjustment operations of the pneumatic actuators are also preferably carried out when at a standstill. The integration of the compressed air leadthrough into the mounting of the cylinder offers the great advantage that this leadthrough can be carried out directly in the center on the axis of the cylinder, so that the transmission of compressed air is possible at any rotational angle of the cylinder. However, only one air duct is possible in this case. If the compressed air leadthrough is located outside the center, then compressed air can be transmitted to the cylinder only in a very small rotational angle range, since the mating pieces on the cylinder and the stationary leadthrough in the side wall must be exactly opposite each other during the compressed air transmission. A plurality of air ducts can be provided in this case for this purpose.

In accordance with yet a further feature of the invention, provision is made for the cylinder to be supplied both with compressed air through a pneumatic leadthrough and with electrical energy and/or electrical signals through a rotary electric transmitter. In this way, both pneumatic actuators and electric actuators or combined pneumatic/electric actuators can be supplied both with energy and with control signals. A particularly compact construction results from the fact that compressed air supply and supply of electrical energy are carried out at the same end of the cylinder. In particular, the rotary leadthrough for the supply of pneumatic energy on the cylinder can be integrated into the electric transmitter. For this purpose, the leadthrough for the pneumatics can be located on the axis of rotation or rotary shaft of the cylinder, while a rotationally symmetrical inductive transmitter is disposed around this axis of rotation or rotary shaft. Such a configuration takes up particularly little overall space and offers high flexibility, since at any time and in any rotational angle position of the cylinder, pneumatic air can be transmitted to the cylinder and, at the same time, electrical energy and signals can reach there through the rotary inductive transmitter.

In accordance with yet an added feature of the invention, provision is made for the positioning electronics of the actuators to be connected to the machine control system of the printing press through a bus system. In this way, the actuators connected to the positioning electronics can be incorporated into the bus system of the machine control system of the printing press. In this case, the data interchange through the rotary transmitter or through radio transmission is also carried out in accordance with the protocol of such a bus system. The data transmitted to the cylinder of the printing press by using the bus system is conditioned appropriately in the positioning electronics for the drive of the actuators. Conversely, the feedback signals from the actuators are packed in the positioning electronics in accordance with the protocol of the bus system and are transmitted through the bus system to the machine control system of the printing press outside the cylinder. In this case, the usual bus systems such as CAN bus, Profibus, or systems based on Ethernet technology, such as Ethercat or Ethernet Powerlink, can be used. In principle, synchronous data transmission can be provided, that is to say it is possible to transmit data simultaneously in both directions, as is the case in radio transmission, for example. Alternatively, the data can also be transmitted asymmetrically, that is to say, for example, data can flow alternately but always in only one direction. In this case, only one transmission channel is required for this purpose, which makes it easier to implement through the use of an optical transmitter. In the case of a specific embodiment, the data is not transmitted directly in the protocol of the bus system through the rotary transmitter either but, in the transmitter, is firstly converted into another protocol which is better able to correct errors in the rotary transmission. On the cylinder, the data is then either processed in the modified form or converted again into the previous protocol or another protocol.

In accordance with yet an additional feature of the invention, apart from the entry of control commands by the operating personnel to the actuators on the cylinder through an electronic operating device which is connected to the machine control system of the printing press, the use of a closed control loop is also possible. In this case, provision is made for there to be an image inspection device at least for the geometric measurement of printed printing materials, which is connected to the machine control system of the printing press. This image inspection device can be used firstly for the color measurement of finished printing materials and also for the geometric measurement in order to determine geometric defects in the printed image. These geometric defects can then be compensated for by the actuators on the plate cylinder through the deformation of the printing plate. In this embodiment, it is advantageous that the printing press has a computer, which processes the measured results from the image inspection device and is capable of carrying out a desired/actual value comparison and, in the event that deviations are determined, of driving the actuators in such a way that the deviations determined are minimized. In this case, the measured results from the image inspection device are transmitted to a computer, which is either integrated into the machine control system or is connected to the latter. The measured results being transmitted are then compared in the computer with a digitized printing original. Should the computer determine that there are deviations from the printing original, then the deviations determined are converted into movement commands of the actuators, in order to deform the printing plate on the cylinder appropriately in such a way that the deviations determined are counteracted. In this way, a closed control loop can be achieved, which automatically corrects geometric deviations registered by measurement through adjusting the actuators. Since there is a relatively large number of actuators on the cylinder, the computer is able to automatically take into account the adjustment of an actuator and its effect on the adjustment of the other actuators relative to one another, while in the case of an adjustment by the operating personnel through an entry device, the latter would have to adjust the actuators little by little, iteratively or else intuitively. As a result, the work is made considerably easier for the operating personnel.

In accordance with again another feature of the invention, in principle, the actuators can be driven individually or in groups. In this case it is, for example, possible to drive a specific group of actuators with the same control commands, while other actuators are given other control commands. In particular, in the case of the manual adjustment through the operating device, it is also possible for the operating personnel to drive each actuator individually through the operating device.

In accordance with again a further feature of the invention, the positioning electronics are integrated into the actuators. In particular, in the case of relatively small sheet-fed presses in smaller formats, there is relatively little space in the cylinders. As a result of the integration of the positioning electronics in the actuators, overall space can be saved in this way. In this manner, the positioning electronics can be integrated into the cylinder even when small-format sheet-fed presses are involved.

In accordance with again an added feature of the invention, provision is made for the cylinder to be a plate cylinder or a blanket cylinder, and for the actuators to be located at least partly in a channel of the cylinder. Clamping bars for fixing printing plates and rubber blankets are normally located in a channel of the associated cylinder. In this way, the clamping bars are disposed in such a way as to be countersunk, so that there is no action on adjacent cylinders on which the blanket cylinder or plate cylinder rolls. The actuators can also be disposed at least partly in this channel, so that they likewise do not project into the radius of adjacent cylinders.

In accordance with a concomitant feature of the invention, provision is advantageously made that, in the event of a geometric change to the cover on the cylinder in the axial direction, any change possibly previously made in the circumferential direction is firstly reversed by driving the actuators and that, after the axial change has been carried out, the change in the circumferential direction is made again. As a result of canceling the change in the circumferential direction, firstly tension is removed from the cover, so that it can be deformed more easily in the axial direction. Therefore, rubbing of the cover on the cylinder is avoided. After the axial change has been carried out, the change in the circumferential direction is then made again. This sequence in the case of an axial change is accomplished automatically through the use of suitably driving the actuators through the machine control system. To this end, the machine control system firstly stores the change carried out in the circumferential direction, in order to be able to make it again after the axial adjustment operation.

Other features which are considered as characteristic for the invention are set forth in the appended claims.

Although the invention is illustrated and described herein as embodied in a printing press with a printing plate manipulation device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, sectional view of a plate cylinder in a printing unit of a sheet-fed printing press, having a plurality of actuators for manipulation of a printing plate;

FIG. 2 is a perspective view showing a configuration of the actuators on the plate cylinder of a sheet-fed printing press;

FIG. 3 is a flow chart showing a sequence of a closed control loop for a correction of deviations through the use of the actuators on a cylinder of a sheet-fed printing press; and

FIG. 4 is a longitudinal-sectional view of a printing press having two printing units, which are supplied with power and signals through a common stator.

### DETAILED DESCRIPTION OF THE INVENTION

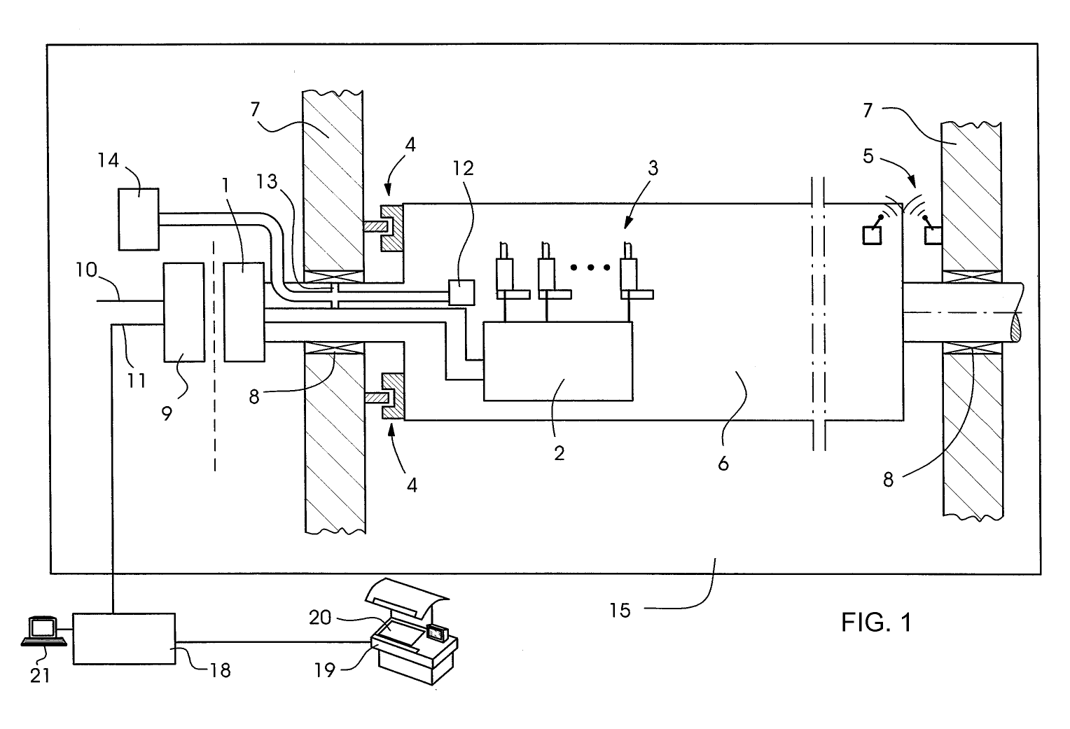

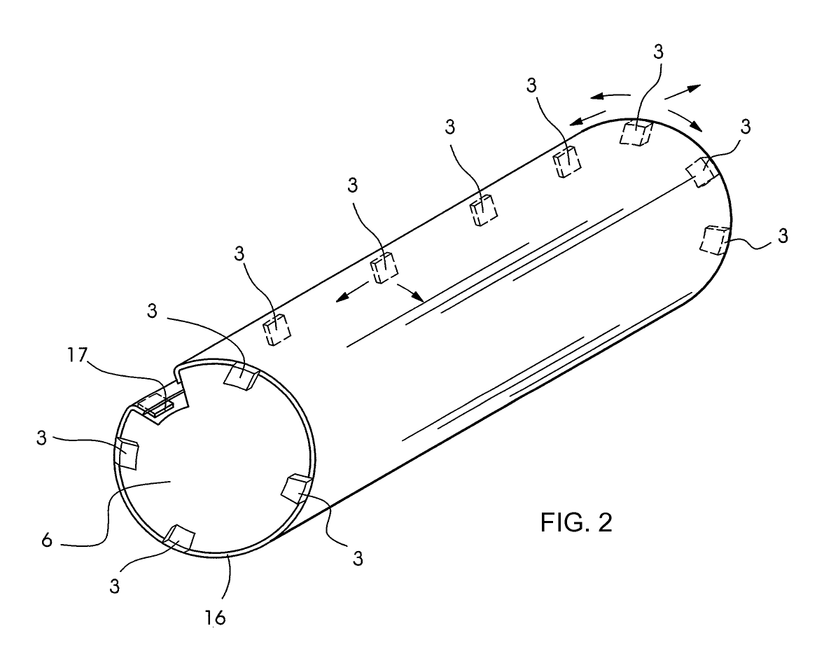

Referring now to the figures of the drawings in detail and first, particularly, to FIG. 1 thereof, there is seen a diagrammatic illustration of a portion of a printing unit of a sheet-fed printing press 15. This portion covers a plate cylinder 6, lateral mountings 8 and, to some extent, driving of actuators 3. The plate cylinder 6 is mounted on both sides in such a way that it can rotate in respective side walls 7 of the printing press 15. A plurality of the actuators 3, which are disposed on the plate cylinder 6, in each case act on outer edges of a printing plate 16 located on the plate cylinder 6, which is illustrated in more detail in FIG. 2. The printing plate 16 located on the plate cylinder 6 can be deformed both in the circumferential direction and in the axial direction by moving the actuators 3. As a result of the deformation of the printing plate 16, a printing image on the plate 16 is changed accordingly at the same time. The actuators 3 in FIG. 1 operate with electric motors, which are connected to positioning electronics 2. These positioning electronics 2 are located in the interior of the plate cylinder 6 and are used to drive the actuators 3. In addition to the electric actuators 3 shown in FIG. 1, there can also be non-illustrated pneumatic actuating elements on the plate cylinder 6, which can be connected to pneumatics 12 on the cylinder. To this end, the mounting 8 of the plate cylinder 6 has a pneumatic rotary leadthrough 13 on the left-hand side, which allows compressed air to be brought to the plate cylinder 6 when the plate cylinder 6 is at a standstill. This compressed air is produced outside the side walls 7 of the printing press 15 in a compressor belonging to a compressed air supply 14.

In order to drive the actuators 3, they have to be supplied with electrical power. This can be done in various ways, and it is possible for the possibilities shown by way of example in FIG. 1 to be implemented alternatively or in parallel. The supply of electrical power is carried out through a rotary inductive transmitter on the left-hand side, which is formed of a rotor 1 and a stator 9. The rotor 1 rotates with the plate cylinder 6, while the stator 9 remains stationary and is connected to an electric power supply 10 of the printing press 15. In this way, even when the plate cylinder 6 is rotating, electrical power can be transmitted continuously to the cylinder 6. In addition, electric control signals 11 coming from a machine control system 18 and sent to the latter can be transmitted through the inductive transmitter by carrier modulation. However, the electric control signals can also additionally or alternatively be transmitted to the cylinder 6 through a radio transmission system 5 shown on the right-hand side. A further possible way of transmitting electric power and electric control signals to the plate cylinder 6 is constituted by an annular transmitter 4 in a gap between the plate cylinder 6 and the side wall 7 of the printing press 15. This annular transmitter 4 also operates on the inductive principle, with a stationary ring rotating in a groove disposed annularly on the plate cylinder 6 and thus being able to transmit inductive power and signals in both directions without contact.

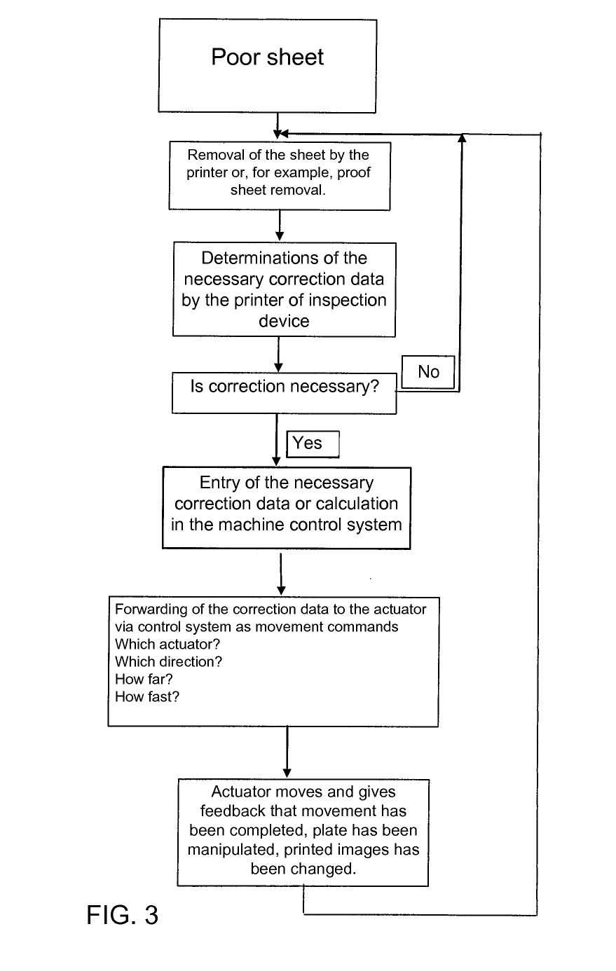

The machine control system 18 of the printing press 15 is connected to an image inspection device 19, on which finally produced printing materials can be laid for inspection. Such a sheet 20 can be registered in terms of color and geometry by the image inspection device 19. The measured results achieved in this way are then transmitted to a computer of the machine control system 18, where the measured actual values are compared with the desired values of a digitally stored printing original from the prepress stage. If the machine control system 18 detects deviations between printing original and measured results from the sheet 20 which lie outside a permissible tolerance, the machine control system 18 is able to convert the deviations detected into control commands for the actuators 3, which are transmitted to the positioning electronics 2 on the plate cylinder 6 as electric control signals 11 through the rotary transmitter including the stator 9 and the rotor 1. The positioning electronics 2 in turn prepare the control commands to the actuators 3 and position the actuators 3 in accordance with the control commands sent. The position to which the actuators 3 actually move is in turn fed back to the positioning electronics 2 and compared there with the control commands. If deviations relating to the control commands are determined, then the actuators 3 are readjusted appropriately until the control commands from the machine control system 18 have been executed with point accuracy. The exact control sequence is explained still more extensively with regard to FIG. 3. Furthermore, an operating device 21 is connected to the machine control system 18 and includes a computer with monitor and keyboard. Through the use of the computer, the operating personnel are able to control the printing press 15 and to enter individual actuating commands to the actuators 3, which are then executed. The action of the actuating commands on the printing plate 16 can firstly be simulated on the monitor of the operating device 21 and can also be displayed to the operating personnel as feedback after the performance of the actuating commands.

FIG. 2 shows that the plate cylinder 6 carries the printing plate 16 which contains the printing image. The printing plate 16 is fixed on the plate cylinder 6 by clamping devices in a channel 17. The clamping devices prevent the printing plate 16 from sliding on the plate cylinder 6 and they are preferably disposed in the channel 17, since there they do not project into the region of adjacent cylinders such as a blanket cylinder or an inking unit. In the region of the channel 17, actuators 3 can also be disposed over the entire length, can act on both ends of the printing plate 16 in the channel 17 and are able to deform the printing plate 16, for example through the use of elongation. The actuators can elongate and stretch the printing plate 16 both in the circumferential direction and in the axial direction of the plate cylinder 6. Furthermore, a plurality of actuators 3 is additionally disposed in the circumferential direction in FIG. 2 and is able to elongate and stretch the printing plate 16 likewise both in the circumferential direction and in the axial direction of the plate cylinder 6. In this way, very precise manipulation of the printing plate 16 on the plate cylinder 6 in all directions is possible, since the printing plate 16 can be manipulated with point accuracy by the plurality of actuators 3. The actuators 3 act laterally on the printing plate 16 and are disposed in such a way as to be countersunk in the lateral region, so that they cannot collide with adjacent revolving parts.

FIG. 3 illustrates in more detail a control loop which becomes effective in the event that deviations of the printing image from the printing original are determined. A sheet 20 which lies outside the permissible tolerances is designated a poor sheet. At regular time intervals, the operating personnel of the printing press 15 remove a sheet 20 and subject it to a visual inspection or optical inspection through the use of the image inspection device 19. The deviations from the printing original determined in the case of a poor sheet require a correction to the printing image on the printing plate 16 of the plate cylinder 6. For this purpose, appropriate correction data has to be calculated either by the printer or by the machine control system 18 connected to the image inspection device 19. If the deviations determined in the region of the geometry lie outside the tolerance, an appropriate correction must be made. In this case, the necessary correction data is either entered into the machine control system 18 by hand by the operating personnel or calculated automatically by the machine control system 18 with knowledge of the digital printing original. In addition, the machine control system 18 converts the correction data into movement commands of the actuators 3, with the machine control system 18 calculating exactly which actuators 3 have to move in which direction and how large this movement must be. In addition, the speed of the movement to be executed can be calculated appropriately in advance by the machine control system 18. The movement commands calculated in this way are then sent from the machine control system 18 to the positioning electronics 2 as electric control signals 11 in order to drive the actuators 3. The respectively driven actuators 3 move in accordance with the movement commands sent and then feed their position back to the positioning electronics 2. When the positioning electronics 2 have determined that an actuator 3 has processed the movement command correctly, appropriate feedback can then be output to the machine control system 18 and signaled to the operating personnel. In addition, the exact position of the actuator 3 can be displayed on the monitor of the operating device 21. In this way, the operating personnel learn exactly how the printing plate 16 has been manipulated and how the printing image located on it has been changed. Therefore, the manipulation operation on the printing plate 16 has been concluded and the machine 15 can resume printing operation again. In this case, the control loop begins from the start when the next proof sheet is removed and once more proved to be a poor sheet.

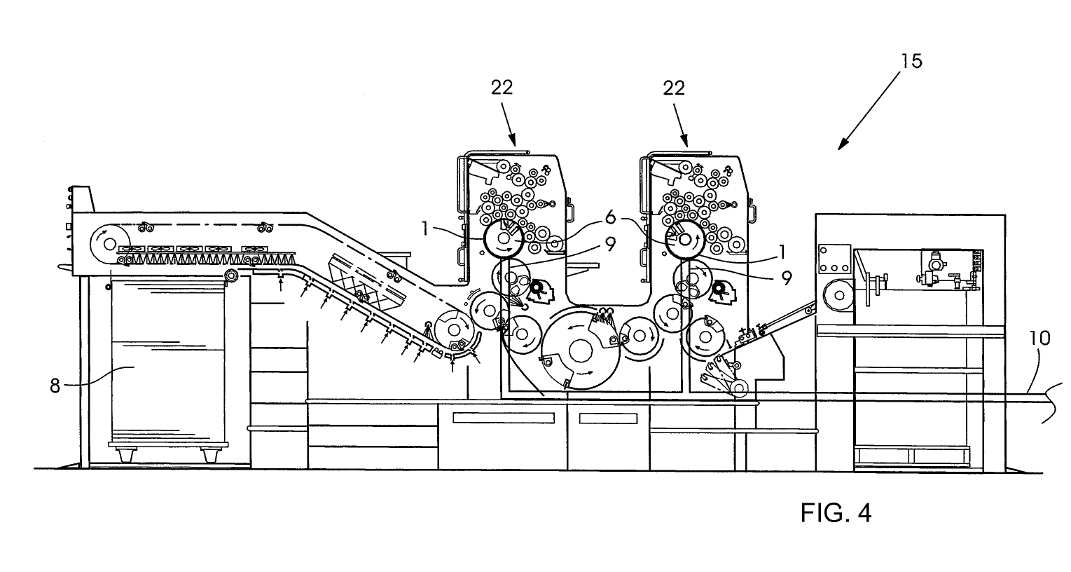

FIG. 4 depicts a specific embodiment with inductive power and signal transmission. A special feature resides in the fact that, in this case, a plurality of printing units 22 have a common stator 9. The stator 9 is a line for power supply, which can additionally also transmit modulated-on signals for control. The line runs through all of the printing units 22 one after another, in each case virtually enclosing the shaft of the plate cylinder 6 annularly and concentrically in the printing units. However, the ring is not quite closed. Instead, at the other end, the line is led again to the next printing unit 22, where a virtually annular configuration is likewise connected. Opposite this open ring, a rotor 1, which rotates on the shaft of the plate cylinder 6 in each case, then transmits the power and data, which flow through the open loop to the next printing unit 22, inductively to the cylinder 6. Since the printing units 22 are connected in series, the power supply through the line 10 must be dimensioned appropriately generously so that there is sufficient power available for all of the cylinders 6. The data has an encoded address, so that it can be processed only by the positioning electronics 2 on the respectively addressed cylinder 6. Of course, an actuating command can also be addressed simultaneously to a plurality of cylinders 6 and then processed by them.

1. A printing press, comprising:
at least one printing unit having a cylinder;
a cover covering said cylinder;
actuators associated with said cylinder for changing a geometry of said cover in at least one of an axial or circumferential direction of said cylinder;
positioning electronics connected to said actuators;
a printing press machine control system connected to said positioning electronics;
an image inspection device connected to said printing press machine control system at least for geometric measurement of printed printing materials; and
a printing press computer processing measured results from said image inspection device for carrying out a desired/actual value comparison and for driving said actuators to minimize determined deviations if deviations are determined.

2. The printing press according to claim 1, wherein said actuators are at least partly electrically driven.

3. The printing press according to claim 1, wherein said actuators have rotationally operating electric motors.

4. The printing press according to claim 2, wherein said actuators have piezoelectric drives.

5. The printing press according to claim 2, wherein said actuators have electromagnetic reciprocating drives.

6. The printing press according to claim 2, wherein said actuators have electric linear motors.

7. The printing press according to claim 2, wherein said actuators have a gear mechanism.

8. The printing press according to claim 1, which further comprises a registering device for feeding back a position of said actuators.

9. The printing press according to claim 8, wherein said registering device has a rotary encoder.

10. The printing press according to claim 8, wherein said registering device has a reference switch.

11. The printing press according to claim 1, wherein said positioning electronics are located on or in said cylinder for driving said actuators.

12. The printing press according to claim 1, which further comprises a rotary transmitter transmitting at least one of electrical energy or electrical data to said cylinder having said actuators.

13. The printing press according to claim 12, wherein said rotary transmitter transmits electrical data to said cylinder synchronously or asynchronously.

14. The printing press according to claim 12, wherein said rotary transmitter is disposed on a rotary shaft or is an annular transmitter.

15. The printing press according to claim 12, wherein said rotary transmitter operates on an induction principle.

16. The printing press according to claim 12, wherein said rotary transmitter transmits at least one of electrical energy or signals to said cylinder through slip rings.

17. The printing press according to claim 12, wherein said rotary transmitter transmits electrical signals to said cylinder optically or capacitively.

18. The printing press according to claim 12, wherein said rotary transmitter operates with radio transmission.

19. The printing press according to claim 12, wherein said rotary transmitter transmits at least one of electrical data or electrical energy at least partly at both ends of said cylinder.

20. The printing press according to claim 1, wherein said actuators operate at least partly pneumatically.

21. The printing press according to claim 1, wherein said actuators are both electric and pneumatic actuators disposed on said cylinder.

22. The printing press according to claim 1, wherein said actuators are combined actuators having both electric and pneumatic functions.

23. The printing press according to claim 20, which further comprises a mounting for said cylinder, said mounting having a leadthrough for a supply of pneumatic energy on said cylinder.

24. The printing press according to claim 22, which further comprises a pneumatic leadthrough for supplying said cylinder with compressed air, and a rotary electric transmitter for supplying said cylinder with at least one of electrical energy or electrical signals.

25. The printing press according to claim 24, wherein said compressed air supply and said supply of electrical energy are carried out at the same end of said cylinder.

26. The printing press according to claim 25, wherein said rotary leadthrough for said supply of pneumatic energy on said cylinder is integrated into said electric transmitter.

27. The printing press according to claim 1, which further comprises a bus system connecting said positioning electronics of said actuators to said printing press machine control system.

28. The printing press according to claim 12, wherein data for transmission through said rotary transmitter by a bus system is transmitted to said cylinder directly or by protocol conversion.

29. The printing press according to claim 1, which further comprises an electronic operating device for entry by operating personnel of control commands for said actuators on said cylinder, said electronic operating device being connected to said printing press machine control system.

30. The printing press according to claim 1, wherein said actuators are driven individually.

31. The printing press according to claim 1, wherein said positioning electronics are integrated into said actuators.

32. The printing press according to claim 1, wherein said cylinder is a plate cylinder or a blanket cylinder and said actuators are located at least partly in a channel formed in said cylinder.

33. The printing press according to claim 32, wherein at least some of said actuators for deforming said cover on said cylinder have a mechanism for clamping fixation of said cover in said channel.

34. The printing press according to claim 12, wherein said at least one printing unit is a plurality of printing units each having a respective rotary transmitter, and a common stator supplies said rotary transmitters with at least one of electrical energy or electrical signals.

35. The printing press according to claim 1, wherein in the event of a geometric change to said cover on said cylinder in the axial direction, any change possibly previously made in the circumferential direction is firstly reversed by driving said actuators and, after the axial change has been carried out, the change in the circumferential direction is made again.
